(19) United States
(12) Patent Application Publication
(10) Pub. No.: US 2019/0075760 A1
(43) Pub. Date: Mar. 14, 2019

(54) MULTIPURPOSE ANIMAL LEASH

(71) Applicants: Dillon David Porter, Salt Lake City, UT (US); Lincoln Parker Porter, Saint Johns (UA)

(72) Inventors: Dillon David Porter, Salt Lake City, UT (US); Lincoln Parker Porter, Saint Johns (UA)

(21) Appl. No.: 16/128,937

(22) Filed: Sep. 12, 2018

Related U.S. Application Data
(63) Continuation of application No. 62/557,372, filed on Sep. 12, 2017.

(51) Int. Cl. A01K 27/00

(52) U.S. Cl. CPC A01K 27/003; A01K 27/002; A01K 27/001

(57) ABSTRACT

A leash capable of being stored on an animal and capable of applying a variable amount of pressure on an animal. The leash is capable of storage around the neck or body of an animal, such as a dog. Then, when use of the leash is desired, the collar or harness is transformed into a leash that places varying pressure on the animal's neck or body so optimal restraint is achieved. The leash can be configured to serve as a collar or harness encompassing either the body of the animal or the animal's neck. The leash is adjustable such that only the appropriate amount of pressure is applied to guide the dog or animal.

### FIELD OF THE INVENTION

The present invention relates to an improved multipurpose animal leash.

### BACKGROUND OF THE INVENTION

A number of leashes are known in the art. However, none offer the versatility taught in the embodiments of the leash described here. Specifically, no known prior art provides a combination of a leash with adjustable lengths enabling the appropriate restraint on the dog or animal, while simultaneously capable of being stored on a collar or harness or other feature found on an animal where a leash or collar/harness is desired.

### SUMMARY OF THE INVENTION

In light of the present advantages and disadvantages inherent in known types of collars found on animals' necks, the present disclosure provides a leash and collar that can be stored as one unit around the animal's neck or body so separate pieces are unnecessary. In some embodiments, when utilized as a leash, the leash offers the leash user ease and convenience and allows the user to unwind and unclasp the leash from the collar or harness (or similar) then lead or restrain the animal.

In some embodiments, a collar capable of performing multiple functions, including use as a leash, is presented.

In other embodiments, a leash capable of being stored on a harness on the animal or collar around the animal's neck is desired.

Another embodiment provides a leash that can allow for appropriate and adjustable pressure constraint on the animal.

Another embodiment provides a dog leash that can also serve as a dog collar.

Another embodiment provides a collar that can store tags and other accessories.

Yet another embodiment provides a dog leash made of a material and having connectors that minimize stress on both user (person desiring restraint or leading and guiding of the leash and the animal.)

Other objects, features and advantages of embodiments will become apparent from the following detailed description taken in conjunction with the accompanying drawings.

### BRIEF DESCRIPTIONS OF THE DRAWINGS

FIG. 1 shows the leash in its standard configuration not yet wrapped around the neck of a dog and in its collar position as an exemplary configuration.

FIG. 2 shows the leash in a collar configuration where the leash portion is extended from the collar and it is unattached and elongated.

FIG. 3 shows the leash/collar in another view where the leash and collar are extended.

FIG. 4 shows the leash/collar in yet another view where the collar is showing and the leash extended therefrom.

FIG. 5 shows the leash as it is integrated as part of a harness/leash rather than collar.

FIG. 6 shows an alternative view of the leash as it extends from a harness configuration.

FIG. 7 shows the leash in its collar configuration around the neck of an animal.

FIG. 8 shows the leash as it is integrated with a harness, where the harness serves to restrain or guide the animal and works to place appropriate pressure on an animal's neck.

### DETAILED DESCRIPTION OF THE DRAWINGS

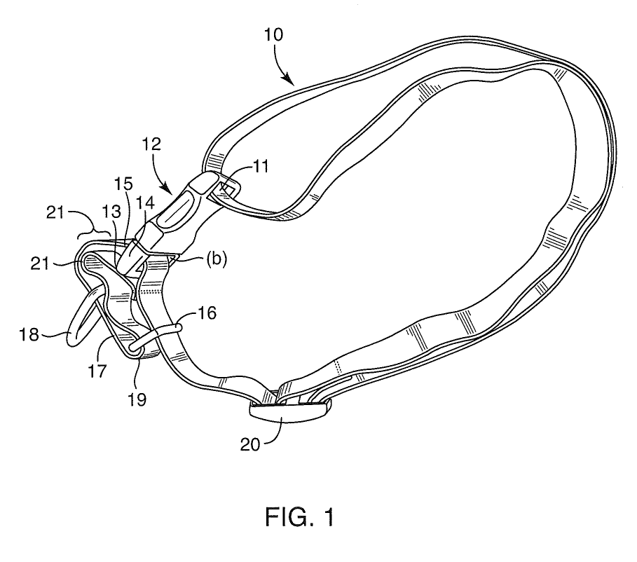

Referring now to FIG. 1, a leash 10 is shown unattached to a dog or animal, but in its collar configuration. Here, one may see the leash 10 can serve as a collar in a way and purpose most animal collars serve, to: provide connection to leash 10, connection to accessories, such as dog tags or other identifying information that identify the dog's owner; or connect to any other sort of accessory that can be connected to the collar. The leash 10/collar material itself can be made of any material safe for use around and on an animal's neck.

In one embodiment, as it appears in the collar configuration, is a first connector 12. The first connector 12 allows the leash 10 to glideably slide through an aperture 11 found in the first connector 12 and attach to a second connector 14, if the leash is desired to be wrapped around a dog's neck and serve as collar. The first connector 12 can connect in a number of ways, such as by clasp, female-male connection, or any other mechanism that allows connection between one part to another.

In some embodiments, the leash 10 uses an adjustment piece 20. This adjustment piece 20 allows for the leash 10 to be maximized or minimized to its fullest or shortest length, respectively. In other words, the adjustment piece 20 allows for the leash 10 to be elongated to serve as a leash 10 or to be minimized, where it can be wrapped around the animal and the leash can be stored on the collar. At its shortest length it is folded over so the leash portion can be wrapped around the collar and the leash 10 is stored on the animal. At the leash 10 and at its longest length, the leash 10 is elongated and serves as leash 10. The adjustment piece 20 enables the leash 10 to be moved along through it, so that the leash 10 varies the length of the leash 10. The adjustment piece 20 can comprise any type of mechanism that enables movement of a material through it in order to elongate or shorten the material that goes through it. When the leash 10 is in the collar configuration, the leash portion is essentially doubled up, wrapped around the collar, and displaying a layer of thickness to the collar.

There is a slip feature 16 with an opening through which the leash 10 is contained and when pulled by the user, restrains the animal. That is, when the leash 10 is through the slip feature 20 and the user pulls the leash away from the animal, pressure then becomes applied to the animal's neck or body depending on whether or not it is in its collar or harness configuration. The slip feature 16 can be any sort of mechanism that has an opening such that the leash 10 can seamlessly glide through it and pressure can be applied to an animal's neck depending on how much the user pulls the leash.

The slip feature 16 can be connected through a number of mechanisms known in the art. One embodiment is shown where the slip feature 16 is connected to a figure eight configuration 17 where the figure eight configuration 17 has a top end (A) 19 and a bottom end (B) 21 through an opening at the top end (A) 19 of the figure eight configuration 17. On the bottom end (B) 21 of the figure eight configuration 17, two additional pieces (piece A 13 and piece B 15) separate to form a triangular feature 21. Within the triangular feature 21, one part of the second connector 14 (either the female or male end) is attached to the piece B 15. The figure eight configuration 17 and the triangular feature 21, allow for accessories or other type of connecting and may have accessory features 18 or similar features to display accessories or connect to something else. That is, the figure eight configuration 17 as it is integrated with the triangular feature 21 can be a sort of element that allows for storage of tags or other accessories and allows the second connector to have some of the leash glideably slide through an aperture 11(b) to be integrated within it such that storage of the leash 10 can be achieved. The other part (female or male) of the first connector 12 is at the end of the leash 10. When the first connector 12 is unclasped, unhinged, or disconnected, the leash 10 is released from being in a collar configuration and can extend through the second connector 14, which then extends from the triangular portion 21. The second connector 14 is also attached to the figure eight configuration 17.

In some embodiments, in the figure eight configuration 17, a seam or other type of securing connection runs between both ends of the figure eight configuration so as to form the figure eight configuration 17 and make two openings capable of holding accessory features 18.

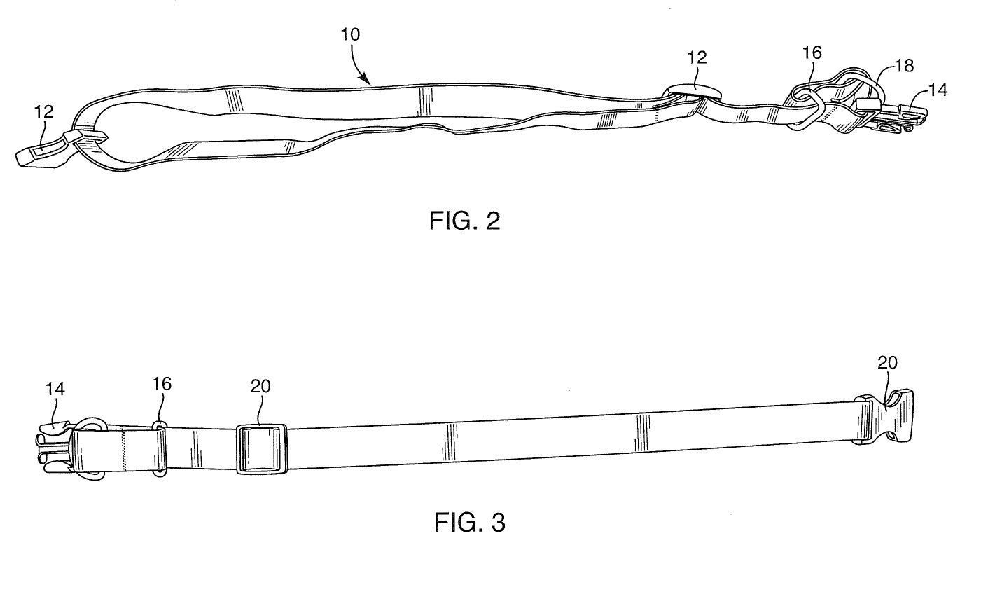

Referring now to FIG. 2, the leash 10 is represented in a way such that the leash 10 is extended out and appears unwrapped. When the first connector 12 is disconnected, unclasped, or unhooked from the second connector 14, the leash portion easily glides through the first connector 12 such that the leash can move within the aperture 11 of the first connector 12. The second connector 14 is on the opposite end of the leash 10 and in the embodiment of FIG. 2 is slideably connected to the triangular configuration 17. However, the second connector 14 can be connected to any configuration capable of holding it. The slip feature 16 is shown with the leash sliding through it. The adjustment piece 20 allows the leash to slip through it and allow for elongation of the leash. If the user pulls on the leash the leash can easily and seamlessly pass through in order for the leash 10 to become extendable. The slip feature 16 and adjustment piece 20 are any types of features that allows for seemless containment and gliding through of materials such as the leash portion. As the user walks the animal, the leash 10 may be pulled or loosened (meaning the leash pulls through or releases through the slip feature 16) depending on the amount of pressure needed to keep the animal under proper restraint. The leash and collar or harness are also comfortable because it does not allow for undue pressure on an animal's neck.

Referring now to FIG. 3, is yet another representation of the leash 10 in extended mode. If the adjustment piece 20 were slid to the right, the leash 10 would elongate as it slips through the slip feature 16 in a way where the leash and collar work together to place appropriate pressure on the animal's neck. That is, when the user pulls the leash 10 and the leash 10 slides through the slip feature 16, this then tightens the collar thereby increasing the pressure of the collar around the animal's neck. Such action serves to guide or restrain the animal. When the leash 10 is no longer needed, then the user can wrap the leash 10 around the neck to form a collar to store the leash 10.

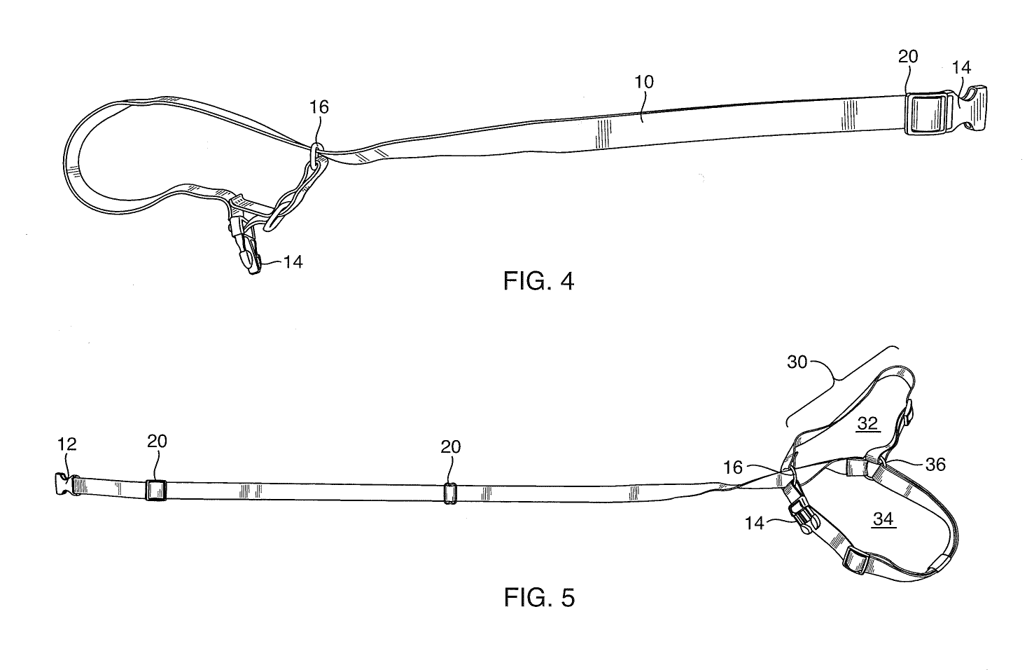

In FIG. 4, yet another view of the collar configuration is represented. In this view of the slip feature 16, the leash 10 that glideably slides through the slip feature 16 thus making the collar smaller or larger is shown. To store in collar mode, the first connector 12 is connected to the second connector 14. The adjustment piece 20 is near the second connector 14 so that the leash is fully elongated.

In FIG. 5, the harness and not the collar form is presented. In this embodiment, a harness can be placed over the animal. The harness has a first opening 32 and a second opening 34. Each of these openings fits around the front legs of an animal. The slip feature functions the same way (in a way that pulls through it and tightens the leash 10), thus restraining the animal. The adjustment piece 20 is also featured and there can be more than one adjustment piece to offer maximum comfort and be appropriately sized to the animal. A holder 36 allows the leash 10 to slideably connect through it so that it connects through the slide feature 16 and also connects to the portions of the leash that fit through the animal's legs.

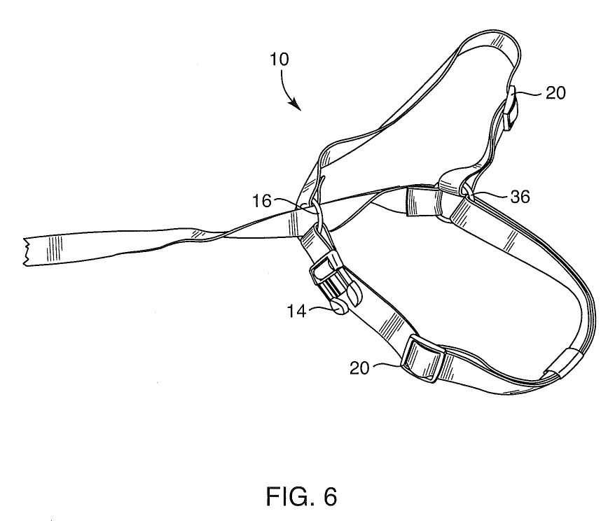

In FIG. 6, a more close up view of the leash 10 in harness form is presented. The slip feature 16 has the leash extend through it. The second connector 14 is displayed. The holder shows connection between the parts of the leash that will hold body through first openings 32 and 34, respectively.

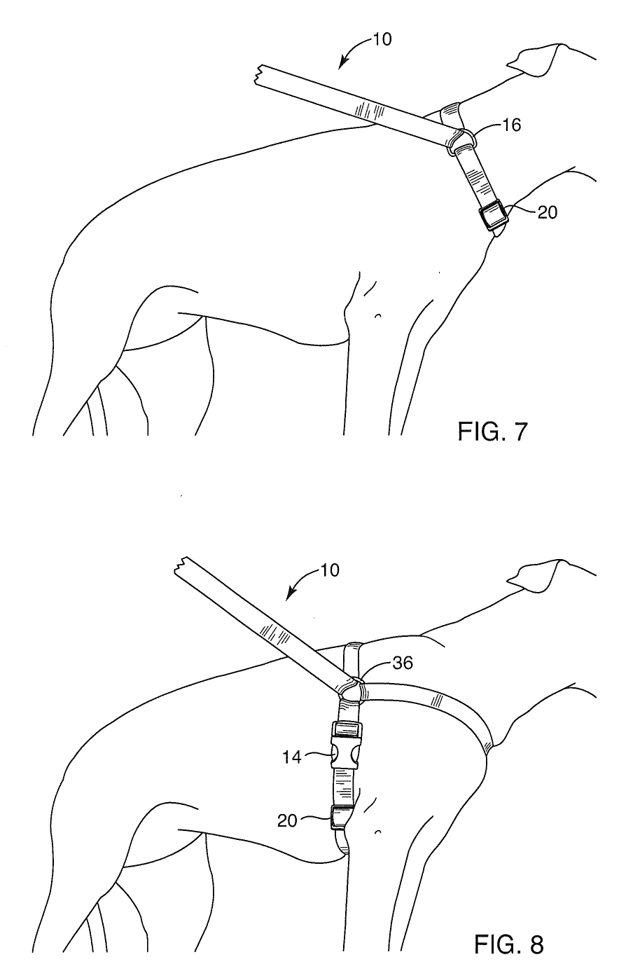

FIG. 7 shows the collar configuration with the leash extending out of it through the slip feature 16. The adjustment piece 20 is shown.

FIG. 8 shows the leash 10 in harness configuration. Here the holder 36, the second connector 14 and the adjustment piece 20 are viewable. The openings 32 and 34 hold body of the animal. The legs of the animal are slipped through either opening and the other opening is placed around the body to form the harness.

With respect to the above description then, it is to be realized that the optimal dimensional relationships for the parts of the invention include variations in size, materials, shape, form, function and manner of operation, assembly and use, are deemed readily apparent and obvious to one skilled in the art, and all equivalent relationships to those illustrated in the drawings and described in the specification and are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A multipurpose leash comprising:
a leash;
a first connector having a first connector aperture, wherein the leash slides through the first connector aperture;
a slip feature having an opening, the leash sliding through the opening; and
a second connector having a second connector aperture, the slip feature being positioned between the first connector and the second connector, the second connector being connectable to the first connector, wherein the leash glideably slides through the second connector aperture.

2. The multipurpose leash of claim 1 further comprising an adjustment piece, allowing for the length of the leash to be modified.

3. The multipurpose leash of claim 1 wherein the multipurpose leash functions as an animal collar when the first connector is connected to the second connector.

4. The multipurpose leash of claim 1 wherein the multipurpose leash functions as an animal leash when the first connector is not connected to the second connector.

5. The multipurpose leash of claim 1 wherein the slip feature allows the multipurpose leash to provide for appropriate and adjustable pressure restraint on an animal wearing the multipurpose leash.

6. The multipurpose leash of claim 1 wherein the leash stores tags.

7. The multipurpose leash of claim 1 where in the slip feature comprises a triangular configuration and wherein the slip feature is slidably connected to the second connector.

8. A multipurpose harness comprising:
a leash;
a first connector having a first connector aperture, wherein the leash slides through the first connector aperture;
a slip feature having an opening, the leash sliding through the opening;
a harness having a first opening and a second opening, the harness being connectable to the leash, a first end of the first opening of the harness connecting to the slip feature and a first end of the second opening of the harness connecting to the slip feature,
a holder, the leash slidably connecting through the holder and also connecting a second end of the first opening of the harness and a second end of the second opening of the harness; and
a second connector having a second connector aperture, the slip feature being positioned between the first connector and the second connector, the second connector being connectable to the first connector, wherein the leash slides through the second connector aperture.

9. The multipurpose harness of claim 8 further comprising an adjustment piece, allowing for the length of the leash to be modified.

10. The multipurpose harness of claim 8 wherein the multipurpose harness functions as an animal collar when the first connector is connected to the second connector.

11. The multipurpose harness of claim 8 wherein the multipurpose harness functions as an animal leash when the first connector is not connected to the second connector.

12. The multipurpose harness of claim 8 wherein the slip feature allows the multipurpose harness to provide for appropriate and adjustable pressure restraint on an animal wearing the multipurpose harness.

13. The multipurpose harness of claim 8 wherein the multipurpose harness stores tags.

14. The multipurpose harness of claim 8 where in the slip feature comprises a triangular configuration and wherein the slip feature is slidably connected to the second connector.
